(19) United States
(12) Patent Application Publication
(10) Pub. No.: US 2013/0002888 A1
(43) Pub. Date: Jan. 3, 2013

(54) APPARATUS FOR EDITING MULTIMEDIA INFORMATION AND METHOD THEREOF

(75) Inventors: Soon Ju KOH, Daejeon (KR); Young Joon Park, Daejeon (KR); Pil Sun Heo, Daejeon (KR); Sung Young Jung, Seoul (KR)

(73) Assignee: Electronics and Telecommunications Research Institute, Daejeon (KR)

(21) Appl. No.: 13/487,695

(22) Filed: Jun. 4, 2012

(30) Foreign Application Priority Data
Jun. 30, 2011 (KR) 10-2011-0064487

(51) Int. Cl. H04N 5/225

(52) U.S. Cl. 348/207.1; 348/E05.024

(57) ABSTRACT

Disclosed are an apparatus for editing multimedia information and a method thereof. The apparatus for editing multimedia information in accordance with the exemplary embodiment of the present invention includes: a display unit the displays a document input window for preparing a document including the multimedia information; a control unit that sets an insertion area for inputting images or moving pictures within the document input window according to a request of a user; and a picture photographing unit that photographs the images or the moving pictures to be input to the insertion area by being driven when the insertion area is set, wherein the control unit inputs the photographed images or moving pictures to the insertion area within the document input window.

### CROSS-REFERENCE TO RELATED APPLICATIONS

This application claims priority to and the benefit of Korean Patent Application No. 10-2011-0064487 filed in the Korean Intellectual Property Office on Jun. 30, 2011, the entire contents of which are incorporated herein by reference.

### TECHNICAL FIELD

The present invention relates to document editing, and more particularly, to an apparatus for editing multimedia information and a method thereof capable of photographing moving pictures or image information by using a mounted camera at the time of setting an insertion area to which the moving pictures or the image information is input during document preparation and automatically inputting the photographed moving pictures or the image information to the insertion area.

### BACKGROUND ART

Recently, the use of mobile terminals with a built-in camera such as smart phones, tablet PCs, netbooks, notebooks, and the like, has been increased and various apparatuses for linking the camera with the mobile terminals in real time have been produced, such that real-time document editing such as a record of travels, minutes, laboratory notes, exploration journals, and the like, has been increased.

A case in which the multimedia information such as pictures, moving pictures in addition to a simple text is inserted into the documents has been increased. In this case, a method of photographing desired scenes by a camera in advance, storing the photographed scenes in a memory or a folder, and then, inserting the stored multimedia files into the document at the time of the document work has been used in order to insert pictures or moving pictures into the documents.

However, the method needs to prepare the multimedia files in advance and as a result, the multimedia information required during the document work may not be present.

In order to solve the disadvantage, various methods have been proposed. Among the methods, Korean Patent Application Laid-Open No. 10-2009-0028057 discloses a method for acquiring and using picture information and image information by using a digital camera or a pen scanner when there is a need to perform an image work during the editing of an electronic document.

However, the disclosed method also uses a scheme of storing the pictures photographed by the camera in a separate memory or file and then, loading the stored pictures in an editor, which leads to slight degradation in efficiency.

### SUMMARY OF THE INVENTION

The present invention has been made in an effort to provide an apparatus for editing multimedia information and a method thereof capable of photographing moving pictures or image information by using a mounted camera at the time of setting an insertion area to which the moving pictures or the image information is input during document preparation and automatically inputting the photographed moving pictures or the image information to the insertion area.

An exemplary embodiment of the present invention provides an apparatus for editing multimedia information, including: a display unit that displays a document input window for preparing a document including the multimedia information; a control unit that sets an insertion area for inputting images or moving pictures within the document input window according to a request of a user; and a picture photographing unit that photographs the images or the moving pictures to be input to the insertion area by being driven when the insertion area is set, wherein the control unit inputs the photographed images or moving pictures to the insertion area within the document input window.

The control unit may display a preview picture input through the picture photographing unit in the insertion area when the insertion area is set.

The control unit may receive the images or the moving pictures photographed by the picture photographing unit during the display of the preview picture in the insertion area and input the provided images or moving pictures to the insertion area within the document input window.

The control unit may input the images or the moving pictures photographed by the picture photographing unit to the insertion area within the document input window and control a size or image quality of the input images or moving pictures.

The picture photographing unit may be physically separated from the control unit to provide the photographed images or moving pictures to the control unit in a wired or wireless manner.

The multimedia information may include texts, images, and moving pictures as information photographed by the picture photographing unit.

Another exemplary embodiment of the present invention provides a method for editing multimedia information, including: displaying a document input window for preparing a document including the multimedia information; setting an insertion area for inputting images or moving pictures within the document input window according to a request of a user; photographing the images or the moving pictures to be input to the insertion area by driving a picture photographing unit when the insertion area is set; and inputting the photographed images or moving pictures to the insertion area within the document input window.

The photographing may include: displaying a preview picture input through the picture photographing unit in the insertion area when the insertion area is set; and photographing the images or the moving pictures by the picture photographing unit during the display of the preview picture.

The method for editing multimedia information may further include: storing the prepared document when the preparation of the document to which the images or the moving pictures are input is completed.

The storing may include: controlling a size or image quality of the input images or moving pictures in the insertion area; and storing the prepared document when the preparation of the document to which the images or the moving pictures is input is completed.

The storing may include: confirming whether the user requests re-photographing; re-photographing the images or the moving pictures by the picture photographing unit and inputting the re-photographed images or moving pictures to the insertion area when the re-photographing is requested; controlling a size or image quality of the input images or the moving pictures in the insertion area; and storing the prepared document when the preparation of the document to which the images or the moving pictures are input is completed.

The storing may include: confirming whether the user requests the re-photographing; controlling the size or the image quality of the input images or the moving pictures in the insertion area when the re-photographing is not requested; and storing the prepared document when the preparation of the document to which the images or the moving pictures are input is completed.

The multimedia information may include texts, images, and moving pictures as information photographed by the picture photographing unit.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exemplified diagram showing an apparatus for editing multimedia information in accordance with an exemplary embodiment of the present invention.

FIG. 2 is an exemplified diagram for describing a principle of setting an insertion area in accordance with the exemplary embodiment of the present invention.

FIG. 3 is a first exemplified diagram showing a method for editing multimedia information in accordance with the exemplary embodiment of the present invention.

FIG. 4 is a second exemplified diagram showing a method for editing multimedia information in accordance with the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

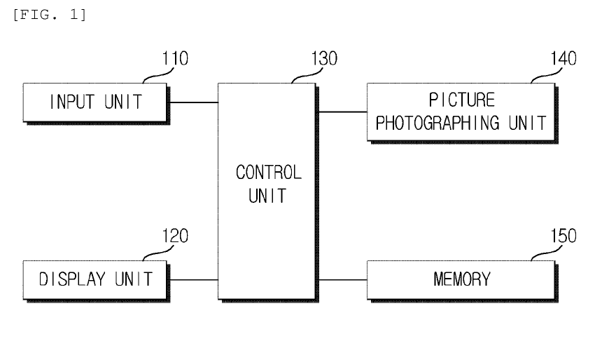

Hereinafter, an apparatus and a method for editing multimedia information in accordance with an exemplary embodiment of the present invention will be described with reference to FIGS. 1 to 4. Components essential to understand an operation and an action of the present invention will mainly be described in more detail. Throughout the specification, like reference numerals proposed in each drawing denotes like components.

The exemplary embodiments of the present invention have proposed a method for photographing moving pictures or image information by using a mounted camera at the time of setting an insertion area to which the moving pictures or the image information is input during document preparation and automatically inputting the photographed moving pictures or the image information to the insertion area. In this case, the multimedia information may include texts, images, moving pictures, and the like.

FIG. 1 is an exemplified diagram showing an apparatus for editing multimedia information in accordance with an exemplary embodiment of the present invention.

As shown in FIG. 1, an apparatus for editing multimedia information in accordance with the exemplary embodiment of the present invention may be configured to include an input unit 110, a display unit 120, a control unit 130, a picture photographing unit 140, a memory 150, and the like. The editing apparatus may be a concept of comprehensively including mobile terminals such as smart phones, tablet personal computers (PCs), netbooks, notebooks, and the like.

The display unit 120 may display a document input window for preparing a document including the multimedia information. When a user wants to prepare the document on the document input window, he/she can input, modify, and delete texts through the input unit 110.

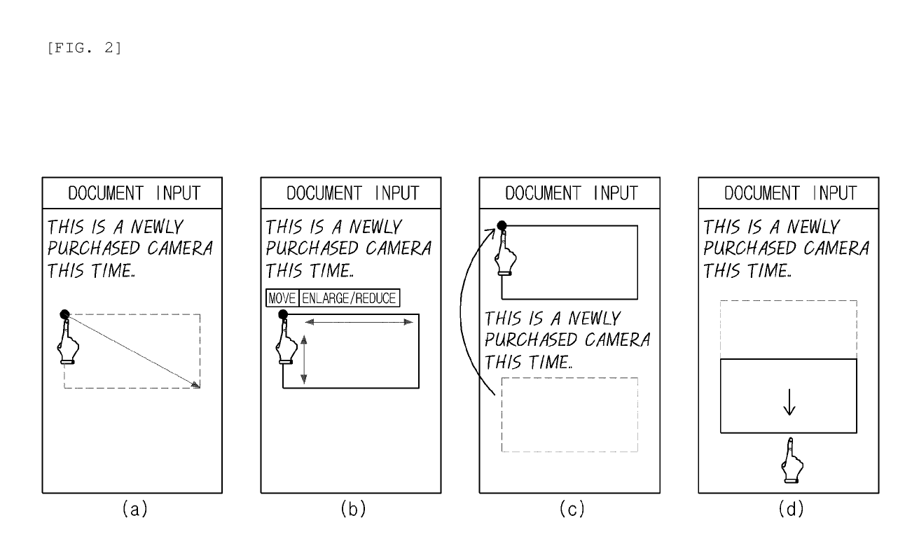

The control unit 130 may set the insertion area for inputting images or moving pictures according to a request of the user within the document input window. This will be described with reference to FIG. 2.

FIG. 2 is an exemplified diagram for describing a principle of setting an insertion area in accordance with the exemplary embodiment of the present invention.

As shown in FIG. 2, the user may set the insertion area for inputting images or moving pictures during the inputting of the texts on the document input window or prior to the inputting of the texts. For example, as shown in FIG. 2A, when the user double-clicks an empty space within the document input window, the term called ‘insertion area setting’ is displayed and when the term is selected, the insertion area may be set. That is, the insertion area having a desired size may be set by moving in a diagonal direction corresponding to a horizontal or vertical size to be set from a point touched by a user's finger or a pen.

The user may move the set insertion area or enlarge or reduce the set insertion area. As shown in FIG. 2B, when double-clicks the set insertion area, the terms moving’ and ‘enlargement/reduction’ may be displayed. When the user selects the term ‘moving’, as shown in FIG. 2C, the already produced insertion area may move from a point touched by a user's finger or a pen to the desired point.

When the user selects the term ‘enlargement/reduction’, as shown in FIG. 2D, the size of the insertion area may be enlarged or reduced by moving in a diagonal direction corresponding to the desired horizontal size or vertical size or the desired horizontal and vertical size from a point touched by a user's finger or a pen.

Here, as a method for setting, moving, enlarging, or reducing the insertion area, a touch scheme is used, but the exemplary embodiment of the present invention is not necessarily limited thereto. Therefore, the setting, moving, enlarging, or reducing of the insertion area may be implemented by using a hotkey, a menu, or the like.

The control unit 130 may drive the picture photographing unit 140 when the insertion area is set. The picture photographing unit 140 photographs images or moving pictures to be input to the predetermined insertion area and may provide the photographed images or moving pictures to the control unit 130. Describing in detail this, the picture photographing unit 140 is driven, a preview picture input through the picture photographing unit 140 may be displayed in the insertion area. While the preview picture is displayed in the insertion area, the user may photograph the desired images or the moving pictures. The photographed images or moving pictures may be provided to the control unit 130 and may be stored to the memory 150.

In this case, the picture photographing unit 140, which is a camera that can photograph the images or the moving pictures, may be embedded in a terminal and may be physically separated from the terminal to transmit information in a wired or wireless manner. That is, the picture photographing unit 140 may transmit the photographed preview picture, images, or moving pictures to the terminal in a wired or wireless manner.

The control unit 130 may store the images or the moving pictures provided from the picture photographing unit 140 to the insertion area set in the document input window and at the same time, input them to the memory 150.

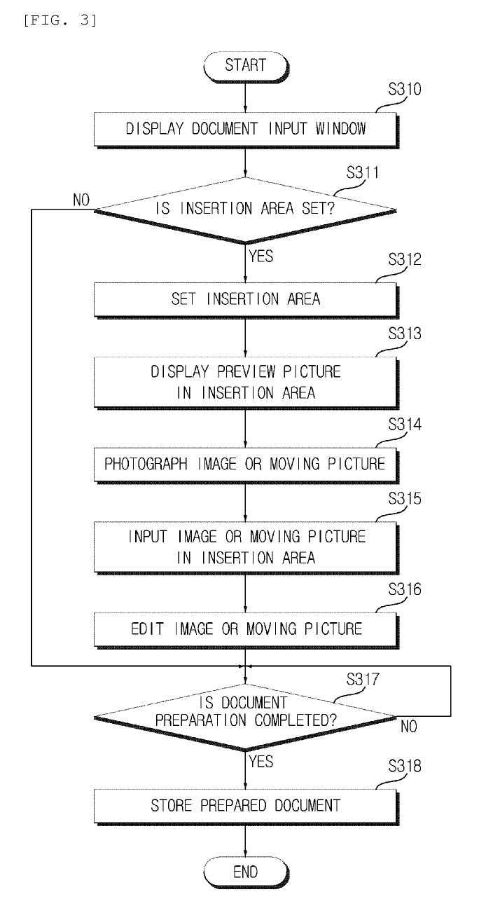

FIG. 3 is a first exemplified diagram showing a method for editing multimedia information in accordance with the exemplary embodiment of the present invention.

As shown in FIG. 3, the apparatus for editing in accordance with the exemplary embodiment of the present invention may display the document input window for preparing the document including the multimedia information according to the request of the user (S310). Next, the editing apparatus can confirm whether the setting of the insertion area is requested (S311). That is, the editing apparatus can set the insertion area for inputting images or moving pictures to the document input window when the setting of the insertion area is requested (S312). On the other hand, the editing apparatus may input the texts to the document input window when the setting of the insertion area is not requested.

In this case, the editing apparatus may 1) allow the user to control the size of the insertion area as needed after the insertion area having a predetermined size is automatically set and 2) set the insertion area while allowing the user to directly control the size of the insertion area, when the user requests the setting of the insertion area.

Next, the editing apparatus may drive the camera when the insertion area is set and display the preview picture input by the driven camera in the insertion area(S313).

Next, the editing apparatus may photograph the image or the moving pictures according to the selection of the user during the display of the preview picture (S314) and input the photographed image or the moving pictures to the predetermined insertion area (S315).

Next, the editing apparatus may edit the input images or moving pictures in the insertion area (S316). That is, the editing apparatus may control the size, image quality, or the like, of the images or the moving pictures through an edited menu that is provided in the document input window.

Next, the editing apparatus can confirm whether the document preparation is completed (S317). That is, the editing apparatus may input the texts to the document input window when the document preparation is not completed.

Next, the editing apparatus may store the prepared document when the document preparation of the user is completed (S318). The stored document may be transmitted through a message service.

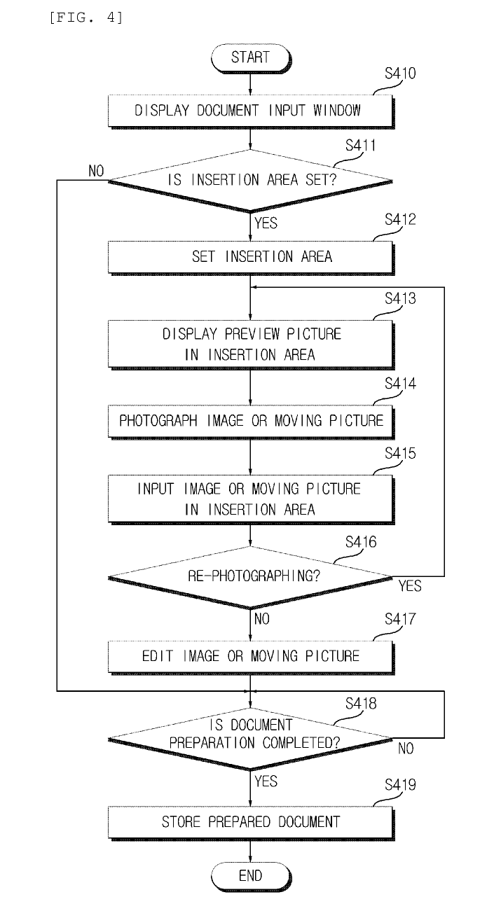

FIG. 4 is a second exemplified diagram showing a method for editing multimedia information in accordance with the exemplary embodiment of the present invention.

As shown in FIG. 4, the apparatus for editing in accordance with the exemplary embodiment of the present invention may display the document input window for preparing the document including the multimedia information according to the request of the user (S410).

Next, the editing apparatus can confirm whether the setting of the insertion area is requested (S411). That is, the editing apparatus can set the insertion area for inputting images or moving pictures to the document input window when the setting of the insertion area is requested (S412). On the other hand, the editing apparatus may input the texts to the document input window when the setting of the insertion area is not requested.

In this case, the editing apparatus may 1) allow the user to control the size of the insertion area as needed after the insertion area having a predetermined size is automatically set and 2) set the insertion area while allowing the user to directly control the size of the insertion area, when the user requests the setting of the insertion area.

Next, the editing apparatus may display the preview picture input through the camera in the insertion area by using a linked menu provided in the document input window when the insertion area is set (S413).

In this case, the linked menu may be a menu for being linked with the camera or a menu for searching the memory. That is, the editing apparatus may receive the images, the moving pictures, or the like, in real time through the camera or receive the pre-stored images, moving pictures, or the like, in the memory.

Next, the editing apparatus may photograph the image or the moving pictures according to the selection of the user during the display of the preview picture (S414) and input the photographed image or the moving pictures to the predetermined insertion area (S415).

Next, the editing apparatus can confirm whether the user requests the re-photographing (S416). That is, the editing apparatus may again display the preview picture in the insertion area when the re-photographing is requested. The editing apparatus may re-photograph the images or the moving pictures according to the selection of the user during the display of the preview picture and may input the re-photographed images or moving pictures in the predetermined insertion area. On the other hand, the editing apparatus may edit the input images or moving pictures in the insertion area when the user does not request the re-photographing (S417). That is, the editing apparatus may control the size, image quality, or the like, of the images or the moving pictures through an edited menu that is provided in the document input window.

Next, the editing apparatus can confirm whether the document preparation is completed (S418). That is, the editing apparatus may input the texts to the document input window when the document preparation is not completed.

Next, the editing apparatus may store the prepared document when the document preparation of the user is completed (S419). The stored document may be transmitted through a message service.

As set forth above, the exemplary embodiments of the present invention can input the multimedia information in real time during the document preparation by photographing the moving pictures or the image information by using the mounted camera at the time of setting the insertion area to which the moving pictures or the image information is input during the document preparation and automatically inputting the photographed moving pictures or the image information to the insertion area.

The exemplary embodiments of the present invention can improve by the convenience of the document work using the multimedia information by photographing the moving pictures or the image information by using the mounted camera at the time of setting the insertion area to which the moving pictures or the image information is input during the document preparation and automatically inputting the photographed moving pictures or the image information to the insertion area.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for editing multimedia information, comprising:
a display unit that displays a document input window for preparing a document including the multimedia information;
a control unit that sets an insertion area for inputting images or moving pictures within the document input window according to a request of a user; and
a picture photographing unit that photographs the images or the moving pictures to be input to the insertion area by being driven when the insertion area is set;
wherein the control unit inputs the photographed images or moving pictures to the insertion area within the document input window.

2. The apparatus of claim 1, wherein the control unit displays a preview picture input through the picture photographing unit in the insertion area when the insertion area is set.

3. The apparatus of claim 2, wherein the control unit receives the images or the moving pictures photographed by the picture photographing unit during the display of the preview picture in the insertion area and inputs the provided images or moving pictures to the insertion area within the document input window.

4. The apparatus of claim 1, wherein the control unit inputs the images or the moving pictures photographed by the picture photographing unit to the insertion area within the document input window and controls a size or image quality of the input images or moving pictures.

5. The apparatus of claim 1, wherein the picture photographing unit is physically separated from the control unit to provide the photographed images or moving pictures to the control unit in a wired or wireless manner.

6. The apparatus of claim 1, wherein the multimedia information includes texts, images, and moving pictures as information photographed by the picture photographing unit.

7. A method for editing multimedia information, comprising:
displaying a document input window for preparing a document including the multimedia information;
setting an insertion area for inputting images or moving pictures within the document input window according to a request of a user;
photographing the images or the moving pictures to be input to the insertion area by driving a picture photographing unit when the insertion area is set; and
inputting the photographed images or moving pictures to the insertion region area within the document input window.

8. The method of claim 7, wherein the photographing includes:
displaying a preview picture input through the picture photographing unit in the insertion area when the insertion area is set; and
photographing the images or the moving pictures by the picture photographing unit during the display of the preview picture.

9. The method of claim 7, further comprising:
storing the prepared document when the preparation of the document to which the images or the moving pictures are input is completed.

10. The method of claim 9, wherein the storing includes:
controlling a size or image quality of the input images or moving pictures in the insertion area; and
storing the prepared document when the preparation of the document to which the images or the moving pictures is input is completed.

11. The method of claim 9, wherein the storing includes:
confirming whether the user requests re-photographing;
re-photographing the images or the moving pictures by the picture photographing unit and inputting the re-photographed images or moving pictures to the insertion area when the re-photographing is requested;
controlling a size or image quality of the input images or the moving pictures in the insertion area; and
storing the prepared document when the preparation of the document to which the images or the moving pictures are input is completed.

12. The method of claim 9, wherein the storing includes:
confirming whether the user requests the re-photographing;
controlling the size or the image quality of the input images or the moving pictures in the insertion area when the re-photographing is not requested; and
storing the prepared document when the preparation of the document to which the images or the moving pictures are input is completed.

13. The method of claim 7, wherein the multimedia information includes texts, images, and moving pictures as information photographed by the picture photographing unit.
